(19) United States
(12) Patent Application Publication
(10) Pub. No.: US 2021/0030013 A1
(43) Pub. Date: Feb. 4, 2021

(54) MULTI STEP ANTI-MICROBIAL INTERVENTION PROCESS UTILIZING AN OXIDIZING TREATMENT FOLLOWED BY A LOW PH TREATMENT

(71) Applicant: CMS TECHNOLOGY, INC., BRIDGEWATER, NJ (US)

(72) Inventors: John MECCIA, Ringoes, NJ (US); Francis DAUTREUIL, Seabrook, TX (US); Ingrid COLE, Ringoes, NJ (US)

(73) Assignee: CMS TECHNOLOGY, INC., BRIDGEWATER, NJ (US)

(21) Appl. No.: 16/967,018

(22) PCT Filed: Feb. 1, 2019
(86) PCT No.: PCT/US19/16323

§ 371 Date: Aug. 3, 2020

Related U.S. Application Data
(60) Provisional application No. 62/625,608, filed on Feb. 2, 2018.

(51) Int. Cl. A23B 4/24; A23B 4/20; A23L 3/3508; A23L 3/358

(52) U.S. Cl. CPC A23B 4/24; A23L 3/358; A23L 3/3508; A23B 4/20

(57) ABSTRACT

Provided are systems and methods for reducing bacterial count on a substrate, such as a foodstuff. The disclosed technology includes treating the substrate with an oxidizing treatment (peracetic acid, for example) followed by treating the substrate with an acidic treatment.

### RELATED APPLICATION

The present application claims priority to U.S. patent application No. 62/625,608, “Multi Step Anti-Microbial Intervention Process Utilizing An Oxidizing Treatment Followed By A Low pH Treatment” (filed Feb. 2, 2018), the entirety of which application is incorporated herein by reference for any and all purposes.

### TECHNICAL FIELD

The present disclosure relates to the field of foodstuff sanitizing, as well as to the fields of oxidizer and acidic treatments of foodstuffs.

### BACKGROUND

The need to sanitize foodstuffs is well-documented, as unclean foodstuffs can pose a health issue. Existing methods of sanitizing foodstuffs—such as treatment with pure peracetic acid—pose challenges, as these methods can give rise to irritating and even harmful vapors to users. Existing methods may also be limited in their effectiveness and may also exhibit slow throughput. Accordingly, there is a long-felt need for improved sanitization systems and methods.

### SUMMARY

In addressing the long-felt needs described above, the present disclosure provides methods of sanitizing substrates—such as foodstuffs—by using an oxidizing treatment and an acidic treatment. Without being bound to any particular theory, the oxidizing treatment can be effective in disrupting the cell walls of bacteria and the acidic treatment in turn can be effective in attacking the metabolic activity of the bacteria, which can be made easier by the disrupted cell walls. For this reason—and again without being bound to any particular theory—it is especially suitable to treat a substrate with an oxidizing treatment (to break down cell walls) followed by an acidic treatment (to disrupt metabolic activity).

In one aspect, the present disclosure provides treatment methods, comprising: (a) contacting a substrate with an oxidizing treatment for a first duration; and (b) following contacting the substrate with the oxidizing treatment, contacting the substrate with an acidic treatment having a pH of less than about 4 for a second duration.

Also provided are systems configured to perform the disclosed methods.

Further provided are systems, comprising: a first treatment region configured to receive a substrate for treatment; a first conduit, the first conduit configured to place a supply of an oxidizing treatment into fluid communication with the first treatment region; and a second treatment region, the second treatment region being configured to receive the substrate for treatment; the first conduit optionally being configured to place a supply of an acidic treatment having a pH of less than about 6 into fluid communication with the first treatment volume; optionally a second conduit, the second conduit configured to place a supply of the acidic treatment into fluid communication with the second treatment volume.

Additionally provided are systems, comprising: a treatment region configured to receive a substrate for treatment; a first conduit, the first conduit configured to place a supply of an oxidizing treatment into fluid communication with the first treatment region; and a second conduit, the second conduit configured to place a supply of an acidic treatment into fluid communication with the treatment volume.

Further provided are systems, comprising: a first treatment region configured to receive a substrate for treatment; a moveable oxidizing treatment module, the moveable oxidizing treatment module being configured to apply an oxidizing treatment to a substrate located at the first treatment region; and a moveable acidic treatment module, the moveable acidic treatment module being configure to apply an acidic treatment having a pH of less than about 4 to a substrate located at the first treatment region.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 provides a depiction of an illustrative system according to the present disclosure;

FIG. 2 provides a depiction of an alternative embodiment of a system according to the present disclosure;

FIG. 3 provides a further embodiment of the disclosed technology;

FIG. 4 illustrates exemplary Salmonella results achieved by the disclosed technology;

FIG. 5 illustrates exemplary Campylobacter results achieved by the disclosed technology;

FIG. 6 illustrates exemplary Salmonella results achieved by the disclosed technology; and

FIG. 7 illustrates exemplary Campylobacter results achieved by the disclosed technology.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Figures

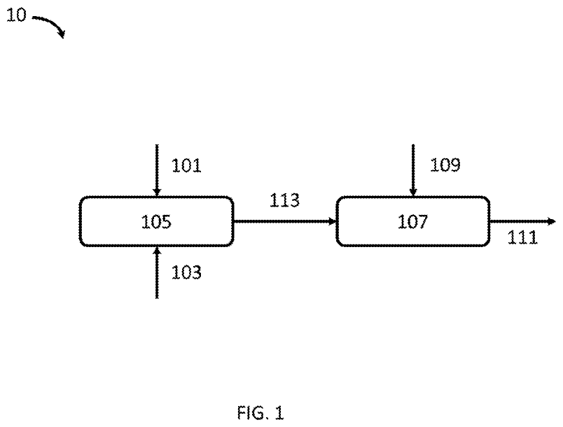

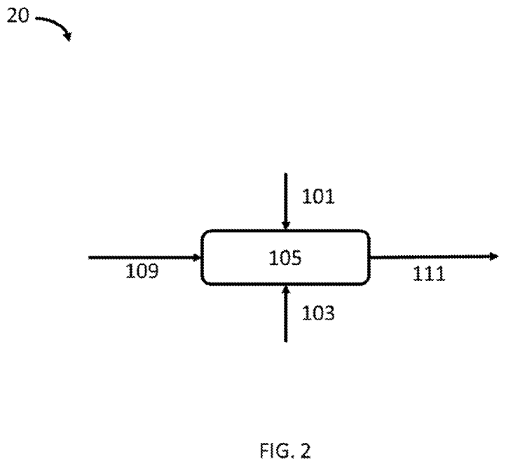

Non-limiting FIG. 1 and FIG. 2 attached hereto provide depictions of exemplary embodiments of the disclosed technology. FIG. 1 depicts an exemplary treatment system 10. As shown, system 10 can include a first location 105. First location 105 can receive a feed of substrate 103 and a feed of oxidizing treatment 101, and the substrate and oxidizing treatment can be contacted to one another in first location 105.

A location can be, e.g., a vessel, a trough, a tank, a chamber, and the like. A location can be sealed, but can also be vented. (Suitable substrates and suitable oxidizing treatments are described elsewhere herein.)

Following contact with the oxidizing treatment, oxidized substrate 113 can be communicated (e.g., via a conveyor or other automated system) to second location 107. In second location 107, the oxidized substrate is contacted with an acidic treatment 109. Following contact with acid treatment 109, treated substrate 111 is communicated (e.g., via a conveyor or other automated system) from second location 107. Treated substrate 111 can be subjected to further downstream processing, e.g., rinsing, inspection/testing, and packaging.

System 10 in FIG. 1 can be operated in a continuous fashion. In this way, substrate 103 can be introduced to first region 105, where the substrate is contacted with oxidizing treatment 101; the contacting can take place while substrate 103 is moving within first region 105. Oxidized substrate 113 can be communicated, e.g., in a continuous fashion, to second region 107, where the oxidized substrate is contacted with acid treatment 109, e.g., while the oxidized substrate is moving within second region 107. Treated substrate 111 can be continuously communicated from second region 107.

System 10 can also be operated in a batch or semi-batch fashion. As an example, substrate 103 can be communicated to first region 105, where substrate 103 is stopped and contacted with oxidizing treatment 101. Oxidized substrate material (113) can then be communicated from first region 105 to second region 107; when first region 105 is vacated by the now-oxidized substrate, a further amount of substrate material can be communicated to the first region 105. Similarly, oxidized substrate 113 can be communicated to second region 107, where the oxidized substrate is stopped and contacted with acid treatment 109. Following that acid treatment, treated substrate 111 can be communicated from second region 107, and further oxidized substrate 113 can be communicated to second region 107, where that oxidized substrate is contacted with acid treatment.

FIG. 1 thus provides an embodiment in which oxidizing and acid treatments each take place in a separate location. This is not, however, a requirement, as shown by FIG. 2's depiction of an alternative treatment system 20.

As shown in FIG. 2, substrate 103 can be communicated to first location 105. Substrate 103 can then be contacted with oxidizing treatment 101 in first location 105, followed by contacting with acidic treatment 109. The substrate can be contacted sequentially first by the oxidizing treatment 101 and then second by the acid treatment 109. The treated substrate 111 can then be subjected to further downstream processing, e.g., rinsing, inspection/testing, and packaging.

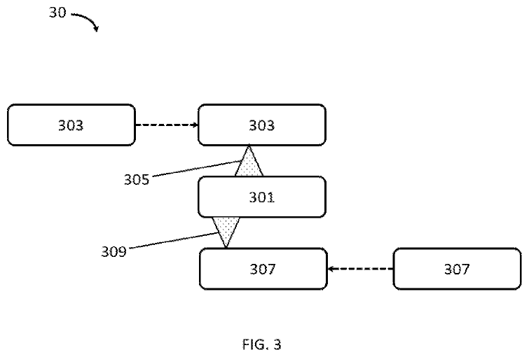

FIG. 3 provides an alternative embodiment of the disclosed technology. As shown in FIG. 3, system 30 can include a treatment region 301 where a substrate (not shown) such as a foodstuff can be disposed. Suitable treatment regions can be, e.g., a platform, a tray, a cart, and the like. A source of oxidizing treatment 303 can be moved into position such that the source of oxidizing treatment is positioned so as to apply the oxidizing treatment 305 to the substrate. Similarly, a source of acidic treatment 307 can be moved into position such that the source of acidic treatment is positioned so as to apply the acidic treatment 309 to the substrate. In this approach, the substrate remains stationary, and the oxidizing and acidic treatments are moveably positioned relative to the substrate so that they can apply their respective treatments to the substrate. Systems according to the present disclosure can be operated in continuous fashion. Systems according to the present disclosure can also be operated in batch fashion; systems according to the present disclosure can also be operated in a semi-batch or semi-continuous fashion.

Exemplary Results

The following results are illustrative of the unexpectedly superior performance of the disclosed technology. These results, however, are not limiting of the disclosed technology.

An exemplary set of experiments were performed to evaluate the disclosed multi-treatment process. These experiments were performed using peracetic acid (PAA) an oxidizing treatment followed by an exemplary acid treatment (“PoultrypHresh”; a sulfuric acid, copper sulfate, and ammonium sulfate blend) to examine efficacy on both Salmonella and Campylobacter (“Campy”). These experiments were performed on split chicken breasts, with skin.

The methods of these experiments were as follows: (1) streak a marker strain of Campylobacter coli and incubate for 48 hours at 42° C. (5% O₂, 10% CO₂, 85% N₂); (2) streak a marker strain of nalidixic acid resistant Salmonella Enteritidis and incubate for 24 hours at 37° C.; (3) obtain skin on, thighs from a local grocer; (4) prepare individual rinse containers; containing 1 L of each; (5) Inoculate thighs with 0.1 mL of inoculum, either Salmonella or Campylobacter; (6) treatments are 6 second dips, 3 thighs for each treatment; (7a) multi-treatment: Treat thigh for 6 seconds at treatment 1 outlined above, remove thigh from bag and place on a clean sheet of aluminum foil for 1 minute, lace the thigh in Treatment 2 as outlined above for 6 sec, remove thigh and allow for a 5 second drip time; (7b) single treatment: Treat thigh for 6 seconds at treatment outlined above. Remove the thigh and allow for a 6 sec drip time; (8) place thighs into an individual rinse bag with 150 mL of BPW and shake by hand for 1 minute; (9) serially dilute rinsates and 0.1 mL from 3 separate dilutions plated onto duplicate campy cefex plates containing 200 ppm gentamicin or duplicate BGS+nal plates; (10) incubate Campy microaerobically for 48 hours at 42° C. Examine plates for Campylobacter coli, colonies count and record, and values log transform values for analysis; (11) incubate Salmonella for 24 hours at 37° C. Examine plates for Salmonella Enteritidis, colonies count and record, and values log transform values for analysis

The results of these illustrative experiments are shown below in Tables 1-4.

TABLE 1
Effectiveness of various treatment approaches against Salmonella.

| | | | | Average | Average |
|---|---|---|---|---|---|
| | | | | Reduction | Reduction |
| | | | | from | from |
| | Treatment 1 | Treatment 2 | Avg Log 10 | Untreated | Water |
| | Untreated | | 5.12 | | |
| | Water | Water | 4.17 | 0.95 | |
| Trial 1 | PoultrypHresh pH = 1.5 | PoultrypHresh pH = 1.5 | 3.18 | 1.94 | 0.99 |
| Trial 2 | PAA 600 ppm | PAA 600 ppm | 2.52 | 2.60 | 1.65 |
| Trial 3 | PoultrypHresh pH = 1.5 | PAA 600 ppm | 2.74 | 2.38 | 1.43 |
| Trial 4 | PAA 600 ppm | PoultrypHresh pH = 1.5 | 2.20 | 2.92 | 1.97 |

| | | | |
|---|---|---|---|
| Trial 5 | PAA 600 ppm | 1.64 | 0.69 |
| Trial 6 | PoultrypHresh pH = 1.5 | 1.19 | 0.43 |

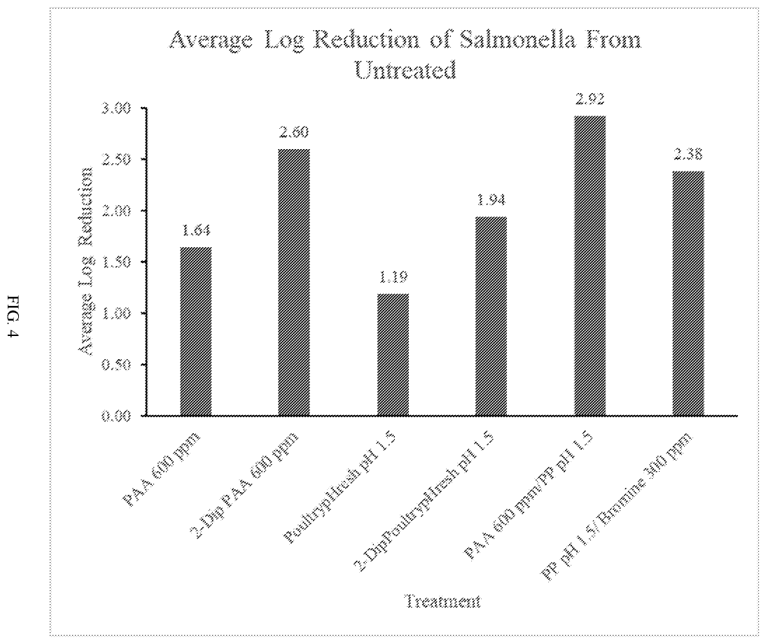

As shown in Table 1 above (and also shown in FIG. 4, which depicts the results of Table 1), the disclosed technology—oxidizer treatment followed by acidic treatment (Trial 4)—exhibited unexpectedly superior performance against Salmonella as compared to other approaches. First, samples inoculated with Salmonella but left untreated exhibited an average count of 5.12 log CFU/cm². A sample that underwent a first wash with water and a second wash with water exhibited a final count after treatment of 4.17 log CFU/cm², which was a reduction of 0.95 log CFU/cm² over an untreated sample. The sample of Trial 1 (acidic treatment followed by acidic treatment) exhibited a count of 3.18 log CFU/cm², which was also an improvement over the untreated sample and the sample of Trial 1.

Trial 2—oxidizing treatment followed by oxidizing treatment—exhibited a count that was superior to the untreated sample as well as the water-treated sample and the sample of Trial 1. Trial 3—acidic treatment followed by oxidizing treatment—exhibited an improvement over the untreated sample, over the water-treated sample, and over the sample of Trial 1, but the count of Trial 3 was inferior to that of Trial 2.

Trial 4—oxidizing treatment followed by acidic treatment—exhibited an unexpectedly superior count as compared to all of the untreated sample, the water-treated sample, Trial 1, and Trial 2. Without being bound to any particular theory, the superior performance of Trial 4 confirms the hypothesis that oxidizing treatment to disrupt cell walls followed by acidic treatment to disrupt metabolic activity results in an effective sanitization process.

TABLE 2
Effectiveness of various treatment protocols against Campy.

| | | | | Average | Average |
|---|---|---|---|---|---|
| | | | | Reduction | Reduction |
| | | | | from | from |
| | Treatment 1 | Treatment 2 | Avg Log 10 | Untreated | Water |
| | Untreated | | 5.46 | | |
| | Water | Water | 4.91 | 0.55 | |
| Trial 1 | PoultrypHresh pH = 1.5 | PoultrypHresh pH = 1.5 | 3.61 | 1.85 | 1.3 |
| Trial 2 | PAA 600 ppm | PAA 600 ppm | 3.05 | 2.42 | 1.87 |
| Trial 3 | PoultrypHresh pH = 1.5 | PAA 600 ppm | 3.46 | 2.00 | 1.45 |
| Trial 4 | PAA 600 ppm | PoultrypHresh pH = 1.5 | 2.52 | 2.94 | 2.39 |

| | | | |
|---|---|---|---|
| Trial 5 | PAA 600 ppm | 0.99 | 0.63 |
| Trial 6 | PoultrypHresh pH = 1.5 | 1.75 | 0.85 |

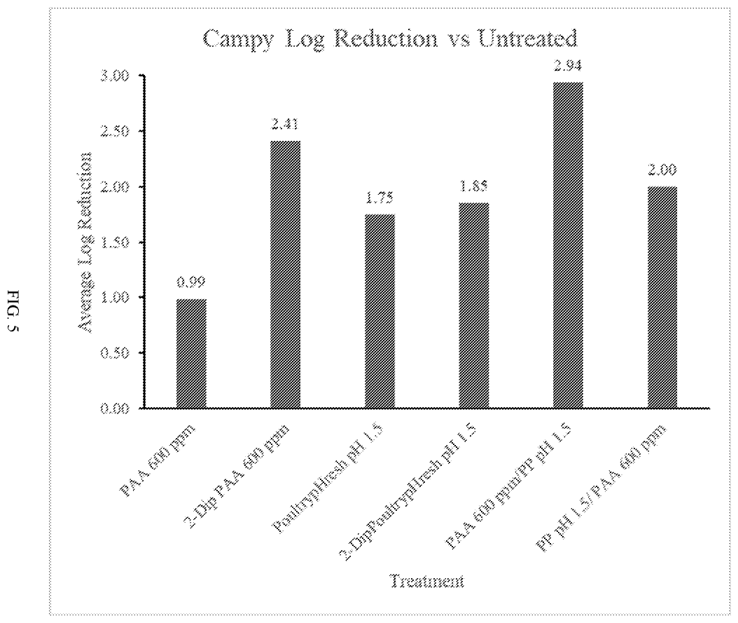

As shown in Table 2 above (and in FIG. 5, which depicts the results of Table 2), the disclosed technology—oxidizer treatment followed by acidic treatment—exhibited unexpectedly superior performance against Campy as compared to other approaches. First, an untreated sample exhibited an average count of 5.46 log CFU/cm². A sample that underwent a first wash with water and a second wash with water exhibited a final count after treatment of 4.91 log CFU/cm², which was a reduction of 0.55 log₁₀ CFU/cm² over an untreated sample. The sample of Trial 1 (acidic treatment followed by acidic treatment) exhibited a count of 3.61 log CFU/cm², which was an improvement over the untreated sample and the sample of Trial 1.

Trial 2—oxidizing treatment followed by oxidizing treatment—exhibited a count that was superior to the untreated sample as well as the water-treated sample and the sample of Trial 1. Trial 3—acidic treatment followed by oxidizing treatment—exhibited an improvement over the untreated sample, the water-treated sample, and the sample of Trial 1, but the count of Trial 3 was inferior to that of Trial 2.

Trial 4—oxidizing treatment followed by acidic treatment—exhibited an unexpectedly superior count as compared to all of the untreated sample, the water-treated sample, Trial 1, and Trial 2.

Again (but without being bound to any particular theory), the superior performance of Trial 4 in Table 2 further confirms the hypothesis that oxidizing treatment to disrupt cell walls followed by acidic treatment to disrupt metabolic activity results in an effective sanitization process.

Further results are shown below. The following results utilize bromine (in the form of hypobromous acid) as an oxidizer.

TABLE 3
Effectiveness of various treatment protocols against Campy.

| | | | | Average | Average |
|---|---|---|---|---|---|
| | | | | Reduction | Reduction |
| | | | | from | from |
| | Treatment 1 | Treatment 2 | Avg Log 10 | Untreated | Water |
| | Untreated | | 5.8 | | |
| | Water | Water | 4.84 | 0.96 | |
| Trial 1 | PoultrypHresh pH = 1.3 | PoultrypHresh pH = 1.3 | 3.79 | 2.01 | 1.05 |
| Trial 2 | Bromine 300 ppm | Bromine 300 ppm | 4.28 | 1.52 | 0.56 |
| Trial 3 | PoultrypHresh pH = 1.3 | Bromine 300 ppm | 3.98 | 1.82 | 0.86 |
| Trial 4 | Bromine 300 ppm | PoultrypHresh pH = 1.3 | 3.52 | 2.28 | 1.32 |

| | | | | |
|---|---|---|---|---|
| Trial 5 | Bromine 300 ppm | 4.52 | 1.28 | 0.32 |
| Trial 6 | PoultrypHresh pH = 1.3 | 4.01 | 1.79 | 0.83 |

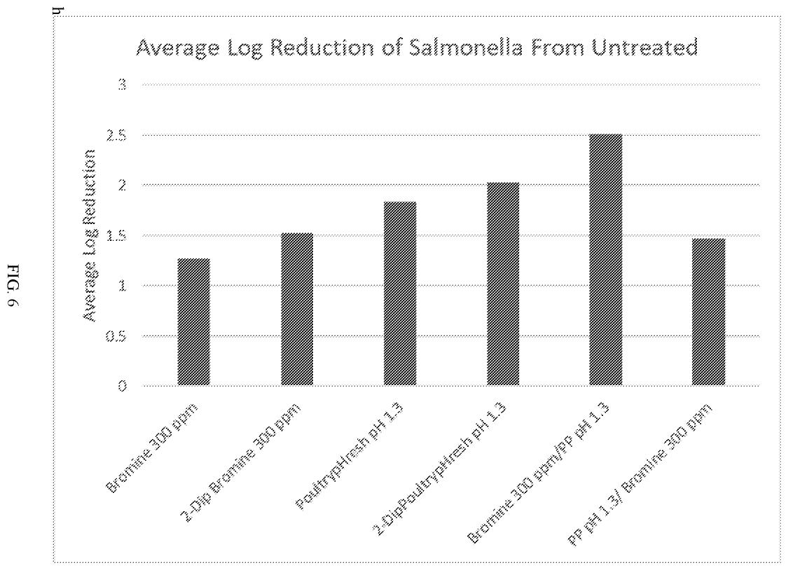

As shown in Table 3 above (and in FIG. 6, which depicts the results in Table 3), the disclosed technology—oxidizer treatment followed by acidic treatment—exhibited unexpectedly superior performance against Campy as compared to other approaches. First, an untreated sample exhibited an average count of 5.8 CFU/cm². A sample that underwent a first wash with water and a second wash with water exhibited a final count after treatment of 4.84 log CFU/cm², which was a reduction over an untreated sample. The sample of Trial 1 (acidic treatment followed by acidic treatment) exhibited a count of 4.52 log CFU/cm², which was an improvement over the untreated sample and the sample of Trial 1.

Trial 2—oxidizing treatment followed by oxidizing treatment—exhibited a count that was superior to the untreated sample as well as the water-treated sample and the sample of Trial 1. Trial 3—acidic treatment followed by oxidizing treatment—exhibited an improvement over the untreated sample, the water-treated sample, and the sample of Trial 1, but the count of Trial 3 was inferior to that of Trial 2.

Trial 4—oxidizing treatment followed by acidic treatment—exhibited an unexpectedly superior count as compared to all of the untreated sample, the water-treated sample, Trial 1, and Trial 2.

Again (but without being bound to any particular theory), the superior performance of Trial 4 in Table 3 above further confirms the hypothesis that oxidizing treatment to disrupt cell walls followed by acidic treatment to disrupt metabolic activity results in an effective sanitization process.

TABLE 4
Effectiveness of various treatment protocols against Salmonella.

| | | | | Average | Average |
|---|---|---|---|---|---|
| | | | | Reduction | Reduction |
| | | | | from | from |
| | Treatment 1 | Treatment 2 | Avg Log 10 | Untreated | Water |
| | Untreated | | 5.46 | | |
| | Water | Water | 4.91 | 0.67 | |
| Trial 1 | PoultrypHresh pH = 1.3 | PoultrypHresh pH = 1.3 | 3.59 | 2.03 | 1.36 |
| Trial 2 | Bromine 300 ppm | Bromine 300 ppm | 3.05 | 1.53 | 0.86 |
| Trial 3 | PoultrypHresh pH = 1.3 | Bromine 300 ppm | 3.46 | 1.47 | 0.8 |
| Trial 4 | Bromine 300 ppm | PoultrypHresh pH = 1.3 | 3.11 | 2.35 | 1.84 |

| | | | |
|---|---|---|---|
| Trial 5 | Bromine 300 ppm | 1.27 | 0.6 |
| Trial 6 | PoultrypHresh pH = 1.3 | 1.84 | 1.17 |

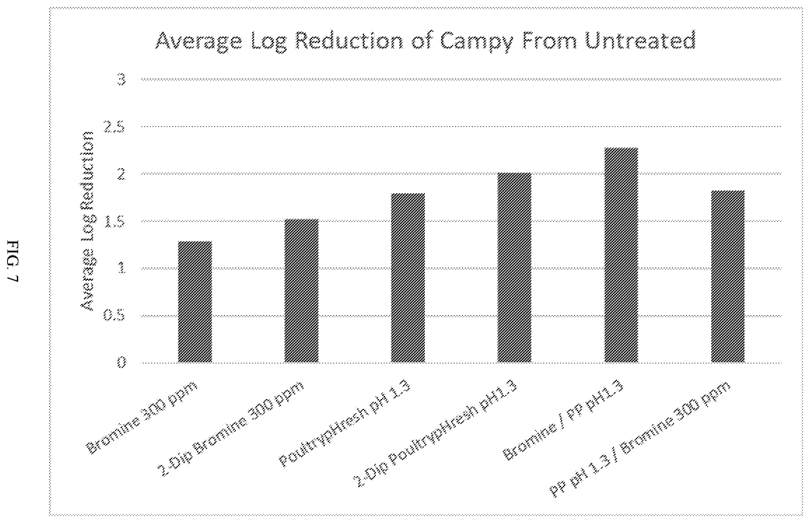

As shown in Table 4 above (and in FIG. 7, which figure depicts the results in Table 4), the disclosed technology—oxidizer treatment followed by acidic treatment—exhibited unexpectedly superior performance against Salmonella as compared to other approaches. First, an untreated sample exhibited an average count of 5.46 log CFU/cm². A sample that underwent a first wash with water and a second wash with water exhibited a final count after treatment of 4.91 log CFU/cm², which was a reduction over an untreated sample. The sample of Trial 1 (acidic treatment followed by acidic treatment) exhibited a count of 2.03 log CFU/cm², which was an improvement over the untreated sample and the sample of Trial 1.

Trial 2—oxidizing treatment followed by oxidizing treatment—exhibited a count that was superior to the untreated sample as well as the water-treated sample and the sample of Trial 1. Trial 3—acidic treatment followed by oxidizing treatment—exhibited an improvement over the untreated sample, the water-treated sample, and the sample of Trial 1, but the count of Trial 3 was inferior to that of Trial 2.

Trial 4—oxidizing treatment followed by acidic treatment—exhibited an unexpectedly superior count as compared to all of the untreated sample, the water-treated sample, Trial 1, and Trial 2.

Again (but without being bound to any particular theory), the superior performance of Trial 4 in Table 2 further confirms the hypothesis that oxidizing treatment to disrupt cell walls followed by acidic treatment to disrupt metabolic activity results in an effective sanitization process.

### Exemplary Embodiments

The following embodiments are illustrative only and do not necessarily limit the scope of the present disclosure or the attached claims.

Embodiment 1. A treatment method, comprising: (a) contacting a substrate with an oxidizing treatment for a first duration; and (b) following contacting the substrate with the oxidizing treatment, contacting the substrate with an acidic treatment having a pH of less than about 6 for a second duration.

The acidic treatment can have a pH of, e.g., from about 6.0 to about 0.1, from about 5.5 to about 0.1, from about 5.0 to about 0.1, from about 4.5 to about 0.1, from about 4.0 to about 0.1, from about 3.5 to about 0.1, from about 3.0 to about 0.1, from about 2.5 to about 0.1, from about 2.0 to about 0.1, or even from about 1.5 to about 0.1. The acidic treatment can have a pH of from, e.g., about 6.0 to about 0.5, from about 5.5 to about 0.5, from about 5.0 to about 0.5, from about 4.5 to about 0.5, from about 4.0 to about 0.5, from about 3.5 to about 0.5, from about 3.0 to about 0.5, from about 2.5 to about 0.5, from about 2.0 to about 0.5, or even from about 1.5 to about 0.5. The pH of the acidic treatment can be, e.g., from about 6.0 to about 1.0, from about 5.5 to about 1.0, from about 5.0 to about 1.0, from about 4.5 to about 1.0, from about 4.0 to about 1.0, from about 3.5 to about 1.0, from about 3.0 to about 1.0, from about 2.5 to about 1.0, from about 2.0 to about 1.0, or even from about 1.5 to about 1.0. The pH of the acidic treatment can be, e.g., from about 6.0 to about 1.5, from about 5.5 to about 1.5, from about 5.0 to about 1.5, from about 4.5 to about 1.5, from about 4.0 to about 1.5, from about 3.5 to about 1.5, from about 3.0 to about 1.5, from about 2.5 to about 1.5, or even from about 2.0 to about 1.5.

Contacting can be effected by, e.g., dipping, spraying, dripping, and the like. Dipping is considered especially suitable. The substrate can be conveyed to a treatment location (e.g., a vessel or spray cabinet) via conveyor, rollers, cart, or by other approaches known in the art.

Alternatively, the substrate can remain stationary, and a vessel, cabinet, or other applicator can be positioned about the substrate so as to allow for application of the oxidizing treatment. In such an embodiment, a substrate can first be treated by a moveable unit (e.g., a spray chamber) that applies an oxidizing treatment, and then by a moveable unit that applies an acidic treatment. In some embodiments, the moveable unit can apply the oxidizing treatment and then the acidic treatment.

It should be understood that the oxidizing treatment and/or the acidic treatment can include one or more additives. Such additives can include, e.g., metals (such as copper and/or silver), surfactants, alcohols, tracers, preservatives, buffers, and the like. Example metals include (without limitation), e.g., copper, zinc, magnesium, and silver. Salts can also be added, e.g., sulfates such as (without limitation) zinc sulfate, copper sulfate, silver nitrate, and magnesium sulfate. Exemplary buffers include salts, e.g., ammonium sulfate, sodium sulfate, calcium sulfate, sodium chloride, and the like. Surfactants can be, e.g., anionic, cationic, and nonionic types of surfactants. Some non-limiting anionic surfactants are, e.g., alcohol sulfates, and alcohol ether sulfates (e.g., sodium lauryl sulfate). Example cationic sulfates include, e.g., alkyl dimethylbenzyl ammonium chlorides and fatty acids. Example nonionic surfactants include, e.g., alkyl polyglucosides, polyethoxy ethers, polygylcol ether derivatives of fatty acids, and polyoxyethylene sorbitons. Additives can also be added separately from either of the oxidizing and acidic treatments.

Embodiment 2. The treatment method of Embodiment 1, wherein the oxidizing treatment comprises peracetic acid, hydrogen peroxide, an inorganic peroxide, a halogen, a percarbonate, an organic persulfate, or any combination thereof.

The concentration of an oxidizer in the oxidizing treatment can be, e.g., from about 2 to about 2000 ppm, e.g., about 2 to about 2000, or about 10 to about 1500, or about 15 to about 1000, or even from about 20 to about 500 ppm. Without being bound to any particular embodiments, a halogen oxidizer can be present at about 15 ppm or less, though this is not a requirement or rule. PAA can be present at, e.g., up to about 2000 ppm, although this too is not a requirement or a rule.

As one example, bromine (which can be present as hypobromous acid) can be present at from, e.g., about 10 to about 500 ppm, or from about 50 to about 250 ppm, or from about 100 to about 200 ppm. Bromine can be present at from about 250 to about 450 ppm, e.g., in a relatively short-duration exposure system. PAA can be present from about 10 to about 2000 ppm, e.g., from about 200 to about 1000 ppm, or even from about 300 to about 800 ppm. In some embodiments (e.g., relatively longer duration exposure), PAA can be present at from about 12 to about 200 ppm. Chlorine oxidizer can be present at from, e.g., about 5 to about 50 ppm, or even from about 20 to about 35 ppm. Peroxides are also suitable, e.g., hydrogen peroxide, alkyl (including multi-alkyl) peroxides, and the like. Hydrogen peroxide can be present at, e.g., from about 50 to about 700 ppm, or from about 100 to about 500 ppm, or even from about 200 to about 400 ppm. Inorganic peroxide(s) can also be used as oxidizers, e.g., sodium peroxide. As an example, an inorganic peroxide can be present at, e.g., from about 50 to about 700 ppm, or from about 100 to about 600 ppm, or from about 200 to about 500 ppm, or even from about 300 to about 400 ppm.

Percabonate(s) can also be used as an oxidizer. A percarbonate (e.g., sodium percarbonate) can be present at, e.g., from about 20 to about 300 ppm, from about 50 to about 200 ppm, or even from about 100 to about 150 ppm. Organic persulfate(s) can also be used as oxidizing treatment. An persulfate (e.g., organic, sodium, ammonium, potassium) can be present, e.g., about 20 to about 300 ppm, or from about 50 to about 200 ppm, or even from about 100 to about 150 ppm. Perborates (e.g., sodium perborate) can also be used as oxidizing treatments.

Peracetic acid is considered an especially suitable oxidizing treatment. Fluorine, chlorine, bromine, and iodine are all considered suitable oxidizing treatments, as are chlorates, hypochlorites, and the like. Sulfur dioxide, hexavalent chromium compounds, permanganates, manganates, ruthenium tetroxide, osmium tetroxide, peroxides, and thallium-containing compounds can also be used. Compounds that are suitable for foodstuff application are considered especially suitable for the disclosed technology.

Embodiment 3. The treatment method of any one of Embodiments 1-2, wherein the first duration is from about 1 second to about 3 hours. The first duration can be, e.g., from about 3 seconds to about 1.5 hours, or from about 5 seconds to about 1 hour, or from about 10 seconds to about 30 minutes, or from about 15 seconds to about 25 minutes, or from about 20 seconds to about 20 minutes, or from about 30 seconds to about 15 minutes, or from about 45 seconds to about 10 minutes, or even from about 1 minute to about 5 minutes. The first duration can be from about 1 second to about 60 seconds, or from about 10 seconds to about 50 seconds, or from about 15 seconds to about 45 seconds, or from about 20 seconds to about 30 seconds.

Embodiment 4. The treatment method of any one of Embodiments 1-3, wherein the acidic treatment has a pH in the range of from about 1 to about 3. The acidic treatment can be a liquid and can be present as a spray or a stream. The acidic treatment can also be present as a pool or other quantity of fluid into which the substrate is dipped. An acidic treatment can also be present as a fluid curtain through which the substrate passes.

Embodiment 5. The treatment method of any one of Embodiments 1-4, wherein the acidic treatment comprises one or both of a mineral acid and an organic acid. Suitable mineral acids include, e.g., phosphoric acid, sulfuric acid, and hydrochloric acid. Suitable organic acids include, e.g., citric acid, lactic acid, acetic acid, propionic acid, sulfonic acid, and other organic acids known to those of skill in the art.

It should be understood that any oxidizing treatment can be combined with any acidic treatment. Specific oxidizing treatment-acidic treatment combinations can be made by a user according to the user's requirements. As described elsewhere herein, PAA is considered an especially suitable oxidizing treatment, and citric acid is considered a suitable acidic treatment.

Embodiment 6. The treatment method of any one of Embodiments 1-5, wherein the second duration is from about 1 second to about 5 minutes. The second duration can be from about 1 to about 5 minutes, or from about 3 seconds to about 90 seconds, or from about 3 to about 70 seconds, or from about 3 to about 60 seconds, or from about 3 to about 50 seconds, or from about 3 to about 40 seconds, or even from about 3 to about 30 seconds.

Embodiment 7. The treatment method of any one of Embodiments 1-6, wherein the substrate is characterized as having an initial bacterial load and wherein the contacting with the oxidixing fluid for the first duration is performed so as to reduce the bacterial load of the substrate by at least about 0.5 log CFU/cm². For example, the reduction can be from about 0.5 log CFU/cm² to about 3.5 log CFU/cm² or even to about 4.5 log CFU/cm².

Embodiment 8. The treatment method of any one of Embodiments 1-7, wherein the substrate is characterized as having an initial bacterial load and wherein the contacting with the oxidizing treatment for the first duration is performed so as to reduce the bacterial load to about 0.5 to about 4.5 log CFU/cm². The load can be reduced to, e.g., about 1 to about 3.5, or about 1.2 to about 3.3, or about 1.5 to about 3.0, or from about 1.7 to about 2.7 log CFU/cm².

Embodiment 9. The treatment method of any one of Embodiments 1-8, wherein the substrate is characterized as having an intermediate bacterial load following contacting with the oxidizing treatment and wherein the contacting with the acidic treatment is performed so as to reduce the bacterial load of the substrate from the intermediate bacterial load by about 1.0 log CFU/cm² or greater. The reduction can be, e.g., from about 1.0 to about 5.0 log CFU/cm², from about 1.2 to about 4.8 log CFU/cm², from about 1.5 to about 4.5 log CFU/cm², from about 1.8 to about 4.2 log CFU/cm², from about 2.0 to about 4.0 log CFU/cm², from about 2.3 to about 3.6 log CFU/cm², or even from about 2.5 to about 3.5 log CFU/cm². The reduction can be 1.5 log CFU/cm² or greater or even 2.0 log CFU/cm² or greater.

Embodiment 10. The treatment method of any one of Embodiments 1-9, wherein the substrate is characterized as having an initial bacterial load and wherein the contacting with the oxidizing treatment and the acidic treatment is performed so as to reduce the bacterial load of the substrate by about 2.0 log CFU/cm² or greater.

Embodiment 11. The treatment method of any one of Embodiments 1-10, wherein the substrate is characterized as a foodstuff.

Embodiment 12. The treatment method of Embodiment 11, wherein the foodstuff comprises a fruit or vegetable.

Embodiment 13. The treatment method of Embodiment 11, wherein the foodstuff is characterized as an animal meat.

Embodiment 14. A system, the system being configured to perform the method of any one of claims 1-13.

Embodiment 15. A system, comprising: a first treatment region configured to receive a substrate for treatment; a first conduit, the first conduit configured to place a supply of an oxidizing treatment into fluid communication with the first treatment region; and a second treatment region, the second treatment region being configured to receive the substrate for treatment; the first conduit optionally being configured to place a supply of an acidic treatment having a pH of less than about 4 into fluid communication with the first treatment volume; optionally a second conduit, the second conduit configured to place a supply of the acidic treatment into fluid communication with the second treatment volume.

The first treatment region can be, e.g., a vessel, a spray cabinet, a pipe, or other structure configured to contain a substrate and the oxidizing treatment. Such a structure can be vented; the structure can also be lined with glass or other material suitable to support the treatment process.

Embodiment 16. The system of Embodiment 15, wherein the system is configured to contact the substrate with the oxidizing treatment by way of a spray, a dip, a stream, a fluidic curtain, or any combination thereof. A dip tank approach is considered especially suitable; sprays and fluidic curtains are also considered suitable. The system can be configured to effect automated (or partially automated) application of the oxidizing treatment; a system can also be configured to support manual application of the oxidizing treatment.

Embodiment 17. The system of any one of Embodiments 15-16, wherein the system is configured to contact the substrate with the acidic treatment by way of a spray, a dip, a stream, a curtain, or any combination thereof.

Embodiment 18. The system of any one of Embodiments 15-17, wherein the system is configured to sequentially contact the substrate with the oxidizing treatment and then the acidic treatment. A system can be configured to rinse the substrate between the substrate's contact with the oxidizing treatment and the acidic treatment, but this is not a requirement, as substrate material can contact the oxidizing treatment and then the acidic treatment without undergoing any intermediate washing steps.

Embodiment 19. The system of any one of Embodiments 15-18, the system being configured to modulate the duration of substrate exposure to the oxidizing treatment, the acidic treatment, or both. A system can be configured to permit a timed exposure of the substrate to the treatment, e.g., a set time of exposure of 30 seconds. The time of exposure can be modulated by the residence time of the substrate as the substrate can pass through a treatment region (e.g., a spray cabinet) in a continuous-type process. The time of exposure can also be modulated by, e.g., submerging the substrate in a first dip tank for a particular period of time, removing the substrate from the tank, and then transporting the substrate to a second dip tank for further treatment.

Embodiment 20. A system, comprising: a treatment region configured to receive a substrate for treatment; a first conduit, the first conduit configured to place a supply of an oxidizing treatment into fluid communication with the first treatment region; and a second conduit, the second conduit configured to place a supply of an acidic treatment into fluid communication with the treatment volume.

Embodiment 21. The system of Embodiment 20, wherein the system is configured to contact the substrate with the oxidizing treatment by way of a spray, a dip, a stream, a curtain, or any combination thereof.

Embodiment 22. The system of any one of Embodiments 20-21, wherein the system is configured to contact the substrate with the acidic treatment by way of a spray, a dip, a stream, a curtain, or any combination thereof.

Embodiment 23. The system of any one of Embodiments 20-22, wherein the system is configured to sequentially contact the substrate with the oxidizing treatment and then the acidic treatment.

Embodiment 24. A system, comprising: a first treatment region configured to receive a substrate for treatment; a moveable oxidizing treatment module, the moveable oxidizing treatment module being configure to apply an oxidizing treatment to a substrate located at the first treatment region; and a moveable acidic treatment module, the moveable acidic treatment module being configure to apply an acidic treatment having a pH of less than about 4 to a substrate located at the first treatment region.

Embodiment 25. The system of Embodiment 24, wherein the moveable oxidizing treatment module comprises a chamber.

Embodiment 26. The system of any one of Embodiments 24-25, wherein the moveable acidic treatment module comprises a chamber.

1. A treatment method, comprising:
(a) contacting a substrate with an oxidizing treatment for a first duration; and
(b) following contacting the substrate with the oxidizing treatment, contacting the substrate with an acidic treatment having a pH of less than about 6 for a second duration.

2. The treatment method of claim 1, wherein the oxidizing treatment comprises peracetic acid, hydrogen peroxide, an inorganic peroxide, a halogen, a percarbonate, an organic persulfate, or any combination of.

3. The treatment method of claim 1, wherein the first duration is from about 1 second to about 3 hours.

4. The treatment method of claim 1, wherein the acidic treatment has a pH in the range of from about 1 to about 3.

5. The treatment method of claim 1, wherein the acidic treatment comprises one or both of a mineral acid and an organic acid.

6. (canceled)

7. The treatment method of claim 1, wherein the substrate is characterized as having an initial bacterial load and wherein the contacting with the oxidizing fluid for the first duration is performed so as to reduce the bacterial load of the substrate by about 0.5 log CFU/cm² or greater.

8. The treatment method of claim 1, wherein the substrate is characterized as having an initial bacterial load and wherein the contacting with the oxidizing treatment for the first duration is performed so as to reduce the bacterial load to about 0.5 to about 4.5 log CFU/cm².

9. (canceled)

10. (canceled)

11. The treatment method of claim 1, wherein the substrate is characterized as a foodstuff.

12. (canceled)

13. (canceled)

14. (canceled)

15. A system, comprising:
a first treatment region configured to receive a substrate for treatment;
a first conduit, the first conduit configured to place a supply of an oxidizing treatment into fluid communication with the first treatment region; and
a second treatment region, the second treatment region being configured to receive the substrate for treatment;
the first conduit optionally being configured to place a supply of an acidic treatment having a pH of less than about 4 into fluid communication with the first treatment volume;
optionally a second conduit, the second conduit configured to place a supply of the acidic treatment into fluid communication with the second treatment volume.

16. The system of claim 15, wherein the system is configured to contact the substrate with the oxidizing treatment by way of a spray, a dip, a stream, a curtain, or any combination thereof.

17. The system of claim 15, wherein the system is configured to contact the substrate with the acidic treatment by way of a spray, a dip, a stream, a curtain, or any combination thereof.

18. The system of claim 15, wherein the system is configured to sequentially contact the substrate with the oxidizing treatment and then the acidic treatment.

19. The system of claim 15, the system being configured to modulate the duration of substrate exposure to the oxidizing treatment, the acidic treatment, or both.

20. A system, comprising:
a treatment region configured to receive a substrate for treatment;
a first conduit, the first conduit configured to place a supply of an oxidizing treatment into fluid communication with the first treatment region; and
a second conduit, the second conduit configured to place a supply of an acidic treatment into fluid communication with the treatment volume.

21. The system of claim 20, wherein the system is configured to contact the substrate with the oxidizing treatment by way of a spray, a dip, a stream, a curtain, or any combination thereof.

22. The system of claim 20, wherein the system is configured to contact the substrate with the acidic treatment by way of a spray, a dip, a stream, a curtain, or any combination thereof.

23. The system of claim 20, wherein the system is configured to sequentially contact the substrate with the oxidizing treatment and then the acidic treatment.

24. A system, comprising:
a first treatment region configured to receive a substrate for treatment;
a moveable oxidizing treatment module, the moveable oxidizing treatment module being configure to apply an oxidizing treatment to a substrate located at the first treatment region; and
a moveable acidic treatment module, the moveable acidic treatment module being configure to apply an acidic treatment having a pH of less than about 4 to a substrate located at the first treatment region.

25. The system of claim 24, wherein the moveable oxidizing treatment module comprises a chamber.

26. The system of claim 24, wherein the moveable acidic treatment module comprises a chamber.
